(19) United States
(12) Patent Application Publication
(10) Pub. No.: US 2007/0006567 A1
(43) Pub. Date: Jan. 11, 2007

(54) Rotating combustion chamber gas turbine engine

(76) Inventor: Mitchel Joseph Matovich JR., La Jolla, CA (US)

Correspondence Address: Mitchel J. Matovich, Jr., 7068 Neptune Place, La Jolla, CA, 92037, US

(21) Appl. No.: 11/155,527

(22) Filed: Jun. 20, 2005

(51) Int. Cl. F02C 3/14

(52) U.S. Cl. 60/39.35

(57) ABSTRACT

A gas turbine engine with a rotating, annular combustion chamber. Said combustion chamber has vanes or jets affixed around its output that are canted in such a manner as to cause the reactive force of the escaping gas to rotate the combustion chamber. The gas then proceeds to impinge on the blades of a turbine wheel driving it in the opposite direction. The two counter-rotating bodies are then coupled to the shaft that drives the compressor stage of the turbine. Said configuration permits operation with higher gas temperatures within the burner which result in higher gas output velocities resulting in efficiency in fuel consumption and relatively clean emissions. The higher output velocities are made possible because the rotation of the gas output nozzles/vanes reduce the velocity of the gas impinging on the turbine blades by the velocity of the nozzles/vanes moving in the opposite direction.

### FIELD OF INVENTION

This invention relates to fuel fired turbine engines and more specifically to turbine engines with rotating combustion chambers (burners).

### DISCUSSION OF THE PRIOR ART

A typical gas turbine engine has combustion chambers where fuel is injected into air fed from a compressor stage and ignited. The burned gas is then directed onto the blades of a turbine wheel driving that wheel into rotation. The efficiency of these turbines is limited by the temperatures and velocities of the output gas which are limited by the thermal and mechanical capabilities of the turbine blades. Prior art, notably that described in U.S. Pat. No. 3,557,551 entitled Gas Turbine Engine With Rotating Combustion Chamber by G. K. C. Campbell describes the advantages of a rotating combustion chamber in improving turbine efficiency but fails to implement the concept as a practical machine. This inventor could not find any prior art that solves the principle problems faced by the Campbell design which include rotating pressure seals, excessive rotational mass and a complex rotating fuel supply system. The invention described herein solves these deficiencies with a new approach to combustion chamber configuration.

### BACKGROUND OF THE INVENTION

Gas turbine engines typically utilize a compressor stage that provides pressurized air to stationary combustion chambers where fuel is injected into the pressurized air and ignited. The burned gas is then directed through nozzles onto the blades of a turbine wheel that is connected to the power shaft driving it into rotation. The efficiency of such turbines is limited by the allowable temperatures and velocities of the output gas. These limitations are imposed by the thermal and mechanical capabilities of the turbine blades which are subject to failure when specific limits have been exceeded.

Prior art such as described in U.S. Pat. No. 3,009,319 entitled Turbojet Engine by G. D. Filipenco used a rotating combustion chamber to solve these limitations but lacked efficiency. U.S. Pat. No. 3,557,551 entitled Gas Turbine Engine With Rotating Combustion Chamber by G. K. C. Campbell describes the advantages of a rotating combustion chamber very well but fails to implement the concept as a practical machine. The Campbell design and iterations of that design, contains features that would make the sealing of the pressurized intake air difficult if not impossible and the rotating of the combustion chamber(s) and the fuel supply assemblies at turbine velocities (rotational speeds of well over 10,000 rpm) would create material stress and balance problems that would make its implementation impractical, even if the fuel feed/flow problems could be solved. (At those rotational velocities a bubble in a fuel line could cause a serious imbalance.)

The invention described herein offers a way of configuring the combustion chamber that eliminates these problems by reducing the rotating mass, eliminating the need for input air seals and allowing the fuel supply system to be mounted in a fixed position.

### OBJECTS AND SUMMARY OF THE INVENTION

One object of the present invention is to provide a gas turbine of high efficiency.

Another object is to provide a gas turbine engine with a high power to weight ratio.

Another object is to provide a gas turbine engine of high power to total air intake ratio.

Another object is to provide a gas turbine engine with cleaner than normal emissions.

Another object is to provide a gas turbine engine that can burn “dirty” fuels.

The disclosed invention is a gas turbine engine that utilizes the reactive force of the high velocity gas jet from the output of the combustion chamber (burner) to rotate the burner thus allowing the use of higher gas temperatures and velocities and it accomplishes this using available materials which have limited temperature and stress capabilities. The combustion chamber is annular in configuration and contains vanes or nozzles mounted around the periphery of its output. (The interior wall configuration of the combustion chamber (burner) and cooling air methodology is neither novel nor new so is not described herein.) The vanes or nozzles direct the burned gasses at an angle that will result in the escaping gas acting as a series of rockets to propel the combustion chamber into rotation.

After being expelled from the combustion chamber through the vanes, or nozzles, the flow of high velocity gas then strikes the blades of the turbine wheel driving it into rotation in the opposite direction. Allowing the combustion chamber wheel to rotate permits the use of very high burner output gas velocities because the velocity at which the gas strikes the turbine blade wheel is reduced by the velocity of the combustion chamber wheel moving in the opposite direction.

Both the turbine wheel and the combustion chamber wheel provide power to the engine output shaft. The power added by the rotating combustion chamber wheel results in a much greater power output for an engine of given size and weight.

Higher gas velocities are attainable with less excess air allowing for a relatively small compressor stage. The compressor stage may be either axial or centrifugal and contain any practical number of stages and the output stage, beyond the first turbine wheel, may contain multiple turbine wheels.

### BRIEF DESCRIPTION OF THE DRAWINGS

FIG. 1 is a front/side view of a gas turbine engine that utilizes a two stage centrifugal compressor intake stage 10, a combustion chamber (burner) stage 24 with vanes or jets 26 at its outlet, a first stage turbine wheel with turbine blades 28 mounted around its outer periphery a set of stationary blades 30 mounted in a manner as to direct the flow of gas to the blades of the second stage turbine wheel 32. After passing over the vanes of the second turbine wheel the gas then passes over a set of exhaust blades 34 which smooth its flow towards the exhaust 36.

FIG. 2 is a half section view of the engine as described in FIG. 1.

### DESCRIPTION OF THE PREFERRED EMBODIMENTS

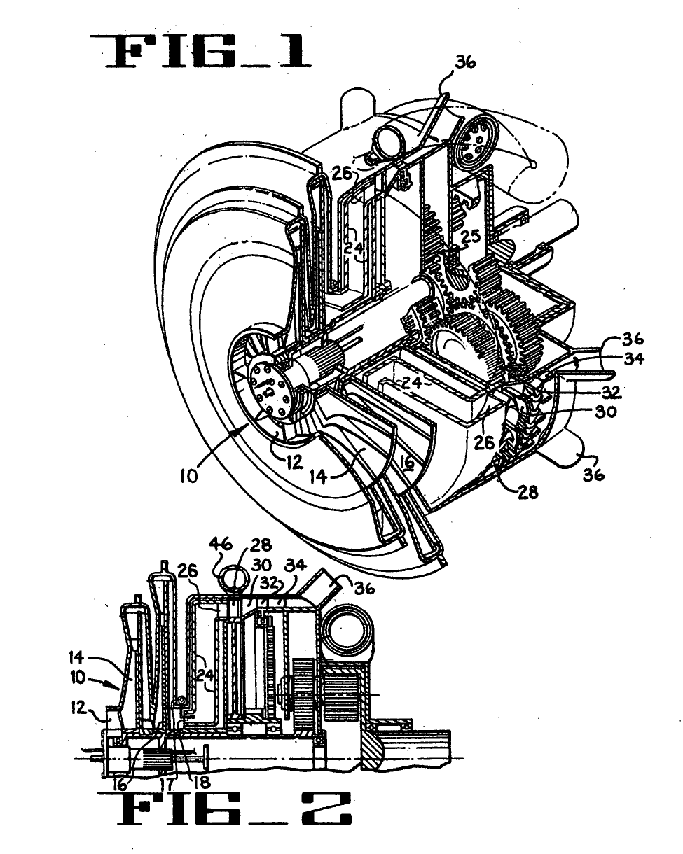

FIG. 1 illustrates a gas turbine engine which is comprised of a compressor 10, (In this case the compressor is a three stage centrifugal compressor) which draws air in through an intake 12 and compresses the air with two compressor wheels 14 and 16 and exhausts the compressed air into the annular combustion chamber (burner) 24 where fuel from a fuel system mounted to the engine housing 17, but protruding through the throat of the combustion chamber, is introduced and ignited near the throat of the burner 18 creating a hot high pressure gas. (The fuel and ignition systems are public domain and are not described herein.)

The combustion chamber is essentially a rotating wheel with vanes or nozzles 26 mounted around its output throat. These vanes or nozzles direct the burned gasses at an angle that has a significant component in the direction of rotation that will propel the combustion chamber into rotation. This flow of high velocity gas then strikes the blades of the first stage turbine wheel 28 driving it in the opposite direction. After passing over the blades of the first stage turbine wheel the gas flow is smoothed and directed by stationary turbine blades 30 into the blades of the second stage turbine wheel 32. After passing from the blades of the second turbine wheel, the flow of the gas is smoothed by stationary vanes 34 and directed into the exhaust chamber 36. The combustion chamber wheel, the first stage turbine wheel and the second stage turbine wheel are coupled to the power output shaft either directly or through gears or other suitable power transmission mechanism.

The input compressed air that supplies the combustion chamber may be supplied through a centrifugal compressor as shown or one with any number of stages or it may be supplied by an axial compressor.

### REFERENCES CITED

U.S. patents

| | | | |
|---|---|---|---|
| 2,710,067 | 6/1995 | Pesaro | 60/39.35X |
| 2,900,789 | 8/1959 | Philpot | 60/270X |
| 3,321,911 | 5/1967 | Myles | 60/39.35 |
| 3,371,718 | 3/1968 | Bacon | 60/39.35 |
| 4,006,591 | 2/1977 | Cervenka | 60/39.5 |
| 4,368,619 | 1/1983 | Levesque | 60/39.5 |
| 5,372,005 | 12/1994 | Lawler | 60/39.5 |
| 5,660,038 | 7/1997 | Stone | 60/39.5 |
| 6,347,507 | 2/2002 | Lawlor | 60/39.5 |

What is claimed is:

1. An engine comprising:
an engine housing;
a rotatably mounted, annular combustion chamber (burner) mounted within that housing;
nozzles or vanes affixed to the output of the rotatably mounted combustion chamber for exhausting a gas in a direction to rotate said combustion chamber;

2. An engine comprising:
an engine housing;
an axial (or centrifugal) compressor mounted within that housing;
an annular combustion chamber (burner) rotatably mounted within that housing;
nozzles or vanes affixed to the output of said combustion chamber for exhausting gas in a direction to drive said combustion chamber into rotation;
a turbine blade wheel mounted adjacent to, and on the same center of rotation as, the rotatably mounted combustion chamber to receive gas jet(s) directly from nozzles vanes or jets mounted to the output of the rotating combustion chamber.
